(19) United States
(12) Patent Application Publication
(10) Pub. No.: US 2006/0230987 A1
(43) Pub. Date: Oct. 19, 2006

(54) Surface-deactivating composition for concrete or mortar comprising a nonionic surfactant

(75) Inventors: Frederic Burgals, Saint-Hilaire de Brethmas (FR); Joel Chaignon, Ecos (FR)

Correspondence Address: OLIFF & BERRIDGE, PLC, P.O. BOX 19928, ALEXANDRIA, VA, 22320, US

(73) Assignee: SIKA TECHNOLOGY AG, Baar (CH)

(21) Appl. No.: 11/280,179

(22) Filed: Nov. 17, 2005

(30) Foreign Application Priority Data
Nov. 25, 2004 (EP) 04292781.4

(51) Int. Cl. C04B 40/00; B05D 3/00

(52) U.S. Cl. 106/823; 427/331

(57) ABSTRACT

A subject-matter of the present invention is a surface-deactivating composition for concrete or mortar comprising at least one setting retarder and at least one nonionic surfactant, and a process for the application of such a composition.

The present invention relates to a composition for deactivating the surface of concrete or mortar, to a process for obtaining a concrete or mortar deactivated using this composition, and to their uses.

Deactivated concretes or mortars are materials in which the surface layer of cement has been removed in order to allow the aggregates to appear in relief and to make it possible to obtain an aesthetic effect.

This is because, for conventional concretes, the surface aspect is determined either by the quality of the mould (vertical surfaces and bottom of mould) or by the quality of the surface finishings obtained by trowelling (horizontal surfaces). The aspect which results therefrom is generally that of a smooth concrete, the colour of which is essentially determined by that of the cement. For some applications, such as road maintenance and facing elements, it is advantageous to provide concretes which, while retaining their structural performances, exhibit a greater variety of aspects. Thus, in order to bring about the appearance of the aggregates, the most widely used methods in the industries for the prefabrication of concrete and ready-mixed concrete, and for concretes prepared on site, consist either in altering the surface of the concrete (after curing and optionally removing from the mould) using mechanical means or in “deactivating” the surface of the concrete during the curing period using chemical retarders known as “surface retarders” or “surface deactivators”.

The concretes intended to be deactivated should preferably exhibit a specific distribution in particle size of the aggregates for the purpose of ensuring that their aspect is uniform when they are visible at the surface.

Having taken these precautions, the deactivation consists in applying, to the surface of the fresh concrete or to the surface of the mould intended to receive the fresh concrete, a compound having a retarding effect on the setting of the cement corresponding to a “surface retarder”. The surface retarder has to be in a concentration such that its delaying effect occurs to a depth of the first few millimetres. Thus, only the surface layer of the concrete will have a delayed setting time. The body of the concrete, for its part, will set normally. When the body of the concrete has sufficiently cured, its surface is cleaned with water (optionally under pressure) or “washed out”. As it has not yet set, the surface layer is removed, bringing about the appearance of the aggregates while leaving them integral with the combined product.

Mention may in particular be made, among surface retarders, of the cyclic aminoplast resins or gluconates disclosed in Patent EP 0 697 381 B1 or the carboxylic acids disclosed in Patent Application EP 1 281 698 A1.

However, with current surface retarders, the time slot for carrying out the cleaning of the surface layer is very short and fluctuates according to the surrounding temperature conditions. Under high temperature conditions (30 to 40° C.), the duration of action of the retarders is of the order of 12 h and, under low temperature conditions (5 to 10° C.), this duration of action is of the order of 36 h. At the same time, the setting time of the body of the concrete will also vary under these same temperature conditions. In the end, and at a given temperature range, the operating range for carrying out the stage of cleaning the surface layer, namely when the setting of the body of the concrete is sufficient and that of the surface layer is incomplete, is of the order of 2 to 3 hours under high temperature conditions and of the order of 4 to 6 hours under low temperature conditions. These relatively short operating ranges place major constraints on the building sites since they make it necessary to regularly carry out tests on control areas. In addition, they require the permanent presence of an operator, sometimes even overnight, and tie down the cleaning equipment (high pressure cleaner) at the same time.

Surprisingly, the Applicant Company has been able to demonstrate that the addition of a nonionic surfactant to a surface retarder makes it possible to obtain a surface-deactivating composition having a much longer duration of action than those of the deactivating compositions of the prior art, which makes it possible to have a much greater operating range. The durations of action and the operating ranges obtained with the composition according to the invention as a function of the temperature are described in Table I below.

TABLE I

| | Duration of action | Operating range |
|---|---|---|
| Temperature (° C.) | (days) | (days) |
| 5 to 10 | 5 | 1.5 to 5 |
| 20 | 10 | 1 to 10 |
| 30 to 40 | 15 | 1 to 15 |

Consequently, a first subject-matter of the invention corresponds to a surface-deactivating composition for concrete or mortar comprising at least one surface retarder, characterized in that it additionally comprises a nonionic surfactant.

Mention may be made, as nonionic surfactant, by way of example, of polyethylene glycol esters, fatty acid esters, ethoxylates (polyoxyethylenated or polyoxypropylenated ethers of fatty alcohols or of fatty acids), sucrose, sorbitol and pentaerythritol esters, and, finally, oxyethylenated or oxypropylenated derivatives of fatty acid esters, aminoalcohols, amides and amines.

According to a preferred embodiment of the invention, the surfactant is chosen from ethoxylates of linear or branched, primary or secondary, C₁₂₋₁₈ alcohols, such as natural or synthetic fatty alcohols, branched alkylphenols with octyl, nonyl or dodecyl groups, fatty acids, fatty amines and fatty acid esters, preferably from aromatic ethoxylates and branched alkylphenols.

According to a second preferred embodiment of the invention, the surfactant is an oxyethylenated or oxypropylenated, saturated or unsaturated, C₁₆₋₁₈ fatty acid ester.

According to a third preferred embodiment of the invention, the surfactant is a fatty acid ester of general formula

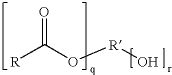

in which R is chosen from an alkyl or an alkenyl with a carbon number of between 2 and 20 and R′ is a polyol P having q+r hydroxyl groups, all the hydroxyl groups of which are removed. Preferably, the said polyol P is chosen from ethylene glycol, propylene glycol, sorbitol, glucose, glucoside, sucrose, pentaerythritol, trimethylolpropane and glycerol. Preferably, the sum of q and r is an integer between 2 and 8, in particular 2, 3 or 4. Preferably, q is 1, 2, 3 or 4. Preferably, r is equal to 0 or 1.

Preferably, the fatty acid ester is chosen from the ester of stearic acid, of oleic acid and of vegetable oil fatty acids.

The amount (by weight) of surfactant in the composition is between 0.2 and 5%, preferably between 0.3 and 3%. Unless otherwise specified, the amounts of the various constituents of the composition according to the invention are expressed as percentage of the weight of each of the said constituents with respect to the total weight of the composition.

Mention may in particular be made, as surface retarder, of a phosphate, an aminophenol, a carbohydrate, or a carboxylic or hydroxycarboxylic acid or acid salt, such as gluconic or glucoheptonic acid or sodium gluconate or glucoheptonate.

According to a preferred embodiment of the invention, the surface retarder is a carbohydrate such as a monosaccharide of general formula Cₙ(H₂O)ₙ with n=5 or 6, such as glucose (n=6), a disaccharide which results from the condensation of two monosaccharides, such as sucrose, lactose and maltose, or a polysaccharide of general formula (C₆H₁₀O₅)_{n′} with n′ between 2 and 10, and the mixtures of these sugars.

According to a second preferred embodiment of the invention, the surface retarder is a carboxylic acid or a salt of such a carboxylic acid.

Mention may be made, as examples of carboxylic acids or their salts, by way of examples, of aromatic carboxylic acids of general formula R″—C₆H₄—COOH, in which R″ is chosen from H, OH, CH₃—COO or C₂H₅O, and carboxylic acids of general formula R′″—COOH, in which R′″ is chosen from COOH and CR₁R₂R₃, with R₁ chosen from H and CH₂—COOH, R₂ chosen from H and OH, and R₃ chosen from H, CH_{3′}—(CHOH)ₓ—CH₂OH and —(CHOH)ₓ—COOH where x is an integer from 1 to 3.

Preferably, the surface retarder is chosen from oxalic acid, succinic acid, malic acid, tartaric acid, citric acid, gluconic acid and their salts.

According to a third preferred embodiment of the invention, the surface retarder is an aminophenol or derivative of the latter, such as para-, ortho- and meta-aminophenol and N-acetylaminophenol.

The amount (by weight) of surface retarder in the composition is between 0.05 and 25%, preferably between 0.1 and 15% and particularly preferably between 0.2 and 10%.

Advantageously, the surface-deactivating composition for concrete or mortar according to the invention additionally comprises at least one polyol.

Mention may be made, as examples of polyols which can be used in the composition according to the invention, of a polyether polyol, a modified polyether polyol comprising a polyurea or a polyurethane in dispersion, a polyvinyl-modified polyether, a polyester polyol, a polycarbonate polyol, a polycaprolactone polyol or a glycol. Preferably, the polyol has a molecular weight of less than 2000 g/mol and it is chosen from a polyether polyol, a polyester polyol and a glycol. More preferably, the polyol is a polyether polyol with a molecular weight of between 50 and 500 g/mol.

Preferably, the polyol is chosen from a triol and a diol.

Preferably, the composition according to the invention comprises a mixture of polyols and particularly preferably a mixture of at least 3 polyols.

The amount (by weight) of polyols in the composition is between 0.1 and 15%, preferably between 0.1 and 10% and particularly preferably between 0.1 and 5%.

In addition to the duration of action, the effectiveness of a deactivating composition is also improved if its viscosity is increased after addition of a thickening compound or “rheology modifier”. This increase in the viscosity makes it possible to restrict the nonuniform dispersion of the composition. This is thus the case when the surface for application is not horizontal or when the levelness of the latter is not satisfactory. The uniform thickness of the composition thus obtained makes it possible to obtain a deactivation which is itself also uniform and an unvarying surface layer of uncured concrete.

The addition of rheology modifiers is known in the prior art. However, the rheology modifiers used in the prior art increase the viscosity of the composition from their introduction into the formulation. Thus, the thickening compounds used in the prior art are used at low concentrations, of the order of 1% or less, to make possible correct spraying of the composition. However, this low concentration does not make it possible to suitably avoid the problems of streaks of the composition after the application thereof. Consequently, the surface layer of uncured concrete obtained after application of such compositions is variable.

Patent Application EP 1 281 698 A1 has been able to demonstrate that the addition to the formulation of a rheology-modifying agent of HASE type (emulsion soluble in alkalis of a hydrophobically modified polymer) makes it possible to obtain a transition of the composition from a liquid state of low viscosity to a very viscous liquid state during contact with fresh concrete. This is because the different chemical nature of this rheology modifier does not modify the rheology of the starting mixture but brings about an increase in the viscosity of the composition on contact with fresh concrete of basic pH. This makes it possible to obtain good spraying of the composition and a uniform and attractive surface condition of the concrete after deactivation, whatever the nature of the surface for application of the composition.

However, the concentrations of HASE used in Patent Application EP 1 281 698 A1 are between 0.5 and 10%.

The Applicant Company has now been able to demonstrate that, at a high concentration, a rheology modifier of HMASE type (aqueous emulsion, soluble in alkalis, of a hydrophobically modified acrylic resin) also acts as “curing product”, which, in the prior art, was generally a resin dissolved in an aliphatic solvent or aqueous compositions based on latex of styrene-butadiene type, the function of which is to limit the drying of the concrete before the “washing out” by the formation of a film.

According to a preferred embodiment of the invention, the surface-deactivating composition for concrete or mortar also comprises a rheology modifier of HMASE type, the concentration of which is preferably between 20 and 50%, preferentially between 30 and 40%.

Advantageously, the rheology modifier of HMASE type can be composed either of homopolymers obtained from acrylic acid, methacrylic acid or acrylamide or of copolymers of the same monomers with in addition acrylic esters in various proportions.

More advantageously, the surface-deactivating composition for concrete or mortar also comprises an oil in aqueous emulsion. This is because the mixture of cutting oil and rheology modifier makes it possible to obtain optimum effectiveness as curing product.

Mention may in particular be made, as example of such oils, of light liquid paraffins.

Preferably, the concentration of cutting oil in the composition according to the invention is between 5 and 10%.

Advantageously, the composition according to the invention additionally comprises at least one antifoaming compound for preventing the composition from foaming during the production and the packaging of the composition.

Advantageously, the composition according to the invention additionally comprises at least one compound for preventing the growth of microorganisms.

The present invention also relates to a process for deactivating the surface of a concrete or of a mortar during the setting thereof, comprising a stage of application of a deactivating composition according to the invention in proportions of the order of 0.20±0.05 litre per square metre of the said surface and a stage of washing this surface with water after a predetermined period.

Another subject-matter of the present invention is the use of a composition according to the invention for deactivating the surface layer of a fresh concrete or mortar.

The composition according to the invention can be used for the deactivation of concrete or mortar produced with any type of cement, in particular cements of CEM I or CEM II type.

Finally, the present invention also relates to the use of a nonionic surfactant for the preparation of a surface-deactivating composition for concrete or mortar according to the invention.

The present invention will be better understood with the help of the following examples. These examples are provided by way of illustration and should not under any circumstances limit the scope of the present invention.

### EXAMPLE 1

Various concrete slabs exhibiting the following composition (in kg/m³) were subjected to various deactivation tests.

| | |
|---|---|
| Cement CEM I 42.5 | 350 kg |
| Sand 0/5 mm | 770 kg |
| Gravel 5/20 mm | 980 kg |
| Plasticizer | 1.5 kg |
| Water | 165 kg |

The constituents were introduced into a 90 litre mixer. After a prehomogenization stage, the water was introduced. The mixing was prolonged for a further 5 minutes and then the concrete was poured into 130 cm×120 cm×2 cm moulds.

Once the concrete had been spread using a metal screed, it was trowelled so as to obtain a perfectly smooth surface and the same orientation of the gravel particles.

Immediately after having smoothed the concrete, a layer of the deactivating composition was applied using a manual sprayer.

The formula of the deactivating composition used is as follows (proportions expressed as percentages by weight):

| | |
|---|---|
| Glucose | 1 |
| Aromatic ethoxylate | 0.5 |
| Polyether polyol | 1.5 |
| HMASE | 35 |
| Oil in emulsion | 7 |
| Bentone | 1 |
| Biocide | 0.5 |
| Antifoaming agent | 1 |
| Water | make up to 100 |

In this example, as in all the following examples, the HMASE used comprises an actual solids content of 30%.

The amount of deactivating composition applied was 0.19 litre per square metre. The temperature was 17° C. during the test with a high degree of humidity.

A washing-out stage was carried out at various times by applying a jet of pressurized water to the concrete slab coated with deactivating agent. The results obtained are summarized in Table II below.

TABLE II

| Days after the pouring | Results |
|---|---|
| of the concrete | obtained |
| 1 | + |
| 2 | ++ |
| 5 | ++ |
| 7 | ++ |

Keys to the table:
− no elimination of the surface layer
−/+ elamination of the surface layer and of the body of the concrete, the aspect is nonuniform with a significant depth
+ resistance-free elimination of the surface layer, nonuniform aspect
++ resistance-free elimination of the surface layer, uniform and homogeneous aspect

The results show that the deactivating composition used makes it possible to obtain a gritted surface of unvarying depth after cleaning of the surface layer. The duration of action of the deactivating composition is between one day and at least seven days.

### EXAMPLE 2

The protocol used for the preparation of the concrete is the same as in Example 1. The formula of the deactivating composition used is as follows (proportions expressed as percentages by weight):

| | |
|---|---|
| Sucrose | 3 |
| Aromatic ethoxylate | 1 |
| Polyether polyol | 3 |
| HMASE | 35 |
| Oil in emulsion | 7 |
| Bentone | 1 |
| Biocide | 0.5 |
| Antifoaming agent | 1 |
| Water | make up to 100 |

The amount of deactivating composition applied was 0.22 litre per square metre. The temperature was 22° C. during the test with significant gusts of wind.

A washing-out stage was carried out at various times by applying a jet of pressurized water to the concrete slab coated with deactivating agent. The results obtained are summarized in Table III below.

TABLE III

| Days after | |
|---|---|
| the pouring | |
| of the | Results |
| concrete | obtained |
| 1 | + |
| 2 | ++ |
| 5 | ++ |
| 10 | ++ |

The results show that the deactivating composition used makes it possible to obtain a gritted surface of unvarying depth after cleaning of the surface layer. The duration of action of the deactivating composition is between one day and at least ten days.

### EXAMPLE 3 (COMPARATIVE)

The protocol used for the preparation of the concrete is the same as in Example 1. The formula of the deactivating composition according to the prior art used is as follows (proportions expressed as percentages by weight):

| | |
|---|---|
| SBR(=styrene/butadiene rubber) latex | 10 |
| Na gluconate | 5 |
| HMASE | 3 |
| Oil in emulsion | 7 |
| Biocide | 0.5 |
| Antifoaming agent | 1 |
| Water | make up to 100 |

The amount of deactivating composition applied was 0.25 litre per square metre. The external temperature was less than 10° C. during the test.

A washing-out stage was carried out at various times by applying a jet of pressurized water to the concrete slab coated with deactivating agent. The results obtained are summarized in Table IV below.

TABLE IV

| Days after | |
|---|---|
| the pouring | |
| of the | Results |
| concrete | obtained |
| 0.75 | −/+ |
| 1 | ++ |
| 2 | + |
| 3 | − |
| 5 | − |
| 7 | − |

The results show that the deactivating composition used makes it possible to obtain a gritted surface of unvarying depth after cleaning of the surface layer. However, the duration of action of this deactivating composition is very limited in time and the range for carrying out the washing-out stage is between the 1st and the 2nd day after application of the composition.

### EXAMPLE 4

The protocol used for the preparation of the concrete is the same as in Example 1. The formula of the deactivating composition used is as follows (proportions expressed as percentages by weight):

| | |
|---|---|
| Glucose | 3 |
| Aromatic ethoxylate | 1 |
| Polyether polyol | 3 |
| HMASE | 35 |
| Oil in emulsion | 7 |
| Bentone | 1 |
| Biocide | 0.5 |
| Antifoaming agent | 1 |
| Water | make up to 100 |

The amount of deactivating composition applied was 0.2 litre per square metre. The temperature conditions were the same as those in Example 3.

A washing-out stage was carried out by applying a jet of pressurized water to the concrete slab coated with deactivating agent at the same time intervals as in Example 3. The results obtained are summarized in Table V below.

TABLE V

| Days after | |
|---|---|
| the pouring | |
| of the | Results |
| concrete | obtained |
| 0.75 | −/+ |
| 1 | ++ |
| 2 | ++ |
| 3 | ++ |
| 5 | ++ |
| 7 | ++ |

The results show that the deactivating composition used makes it possible to obtain a gritted surface of unvarying depth after cleaning of the surface layer, as is the case for the composition of the prior art. However, the duration of action of the deactivating composition according to the invention is much longer at a temperature of less than 10° C. than that of the prior art. Specifically, this duration of action is between one day and at least seven days for the composition according to the invention whereas the duration of action of the composition of the prior art is limited to the range from 24 to 48 hours.

### EXAMPLE 5

In this example, a “ready-mixed” mortar Chapdur Décor Désactivé® (SIKA) was prepared according to the manufacturer's instructions. The concrete slabs were poured with this mortar according to the same procedure as in Example 1. The formula of the deactivating composition used is as follows (proportions expressed as percentages by weight):

| | |
|---|---|
| Glucose syrup | 6 |
| Aromatic ethoxylate | 2 |
| Polyether polyol | 5 |
| HMASE | 37 |
| Oil in emulsion | 7 |
| Bentone | 1.5 |
| Biocide | 0.5 |
| Antifoaming agent | 1 |
| Water | make up to 100 |

Immediately after having smoothed the concrete, a layer of the deactivating composition is applied using a compressed air sprayer. The amount applied is 0.27 litre per square metre. The temperature was 34° C. during the test.

A washing-out stage was carried out at various times by applying a jet of pressurized water to the concrete slab coated with deactivating agent. The results obtained are summarized in Table VI below.

TABLE VI

| Days after | |
|---|---|
| the pouring | |
| of the | Results |
| concrete | obtained |
| 1 | + |
| 2 | ++ |
| 5 | ++ |
| 16 | ++ |

The results show that the deactivating composition used makes it possible to obtain a gritted surface of unvarying depth after cleaning of the surface layer. The duration of action of the deactivating composition is between one day and at least sixteen days.

### EXAMPLE 6

Various concrete slabs exhibiting the following composition (in kg/m³) were subjected to various deactivation tests.

| | |
|---|---|
| Cement CEM I 42.5 | 500 kg |
| Sand 0/3 mm | 1500 kg |
| Plasticizer | 2 kg |
| Water | 230 kg |

The constituents were introduced into a 90 litre mixer. After a prehomogenization stage, the water was introduced. The mixing was prolonged for a further 5 minutes and then the concrete was poured into 50 cm×100 cm×2 cm moulds.

Once the concrete had been spread using a metal screed, it was trowelled so as to obtain a perfectly smooth surface.

Immediately after having smoothed the concrete, a layer of the deactivating composition was applied using a manual sprayer.

The formula of the deactivating composition used is as follows (proportions expressed as percentages by weight):

| | |
|---|---|
| N-Acetylaminophenol | 0.4 |
| Ethoxylated alkylphenol | 0.5 |
| Polyether polyol and polyester polyol | 3 |
| HMASE | 30 |
| Oil in emulsion | 9 |
| Biocide | 0.5 |
| Antifoaming agent | 1 |
| Water | make up to 100 |

The amount of deactivating composition applied was between 0.20 and 0.25 litre per square metre. The entire test was carried out inside the laboratory, at a temperature of between 18 and 22° C.

A washing-out stage was carried out at various times by applying a jet of pressurized water to the concrete slab coated with deactivating agent. The results obtained are summarized in Table VII.

### EXAMPLE 7

The protocol used for the preparation of the concrete is the same as in Example 6. The formula of the deactivating composition used is as follows (proportions expressed as percentages by weight):

| | |
|---|---|
| N-Acetylaminophenol | 0.4 |
| Ethoxylated alkylphenol | 1 |
| Polyether polyols | 3 |
| HMASE | 30 |
| Oil in emulsion | 9 |
| Biocide | 0.5 |
| Antifoaming agent | 1 |
| Water | make up to 100 |

The application and washing conditions for this composition were the same as those in Example 6. The results obtained are summarized in Table VII.

### EXAMPLE 8

The protocol used for the preparation of the concrete is the same as in Example 6. The formula of the deactivating composition used is as follows (proportions expressed as percentages by weight):

| | |
|---|---|
| N-Acetylaminophenol | 0.8 |
| Oxypropylenated stearate | 1 |
| Polyether polyol and polyester polyol | 3 |
| HMASE | 35 |
| Oil in emulsion | 9 |
| Biocide | 0.5 |
| Antifoaming agent | 1 |
| Water | make up to 100 |

The application and washing conditions for this composition were the same as those in Example 6. The results obtained are summarized in Table VII.

### EXAMPLE 9

The protocol used for the preparation of the concrete is the same as in Example 6. The formula of the deactivating composition used is as follows (proportions expressed as percentages by weight):

| | |
|---|---|
| Na gluconate | 3 |
| Ethoxylated alkylphenol | 0.5 |
| Polyether polyol and polyester polyol | 2 |
| HMASE | 35 |
| Oil in emulsion | 9 |
| Biocide | 0.5 |
| Antifoaming agent | 1 |
| Water | make up to 100 |

The application and washing conditions for this composition were the same as those in Example 6. The results obtained are summarized in Table VII.

### EXAMPLE 10

The protocol used for the preparation of the concrete is the same as in Example 6. The formula of the deactivating composition used is as follows (proportions expressed as percentages by weight):

| | |
|---|---|
| Na gluconate | 5 |
| Oxypropylenated stearate | 1 |
| Polyether polyols | 3 |
| HMASE | 35 |
| Oil in emulsion | 9 |
| Biocide | 0.5 |
| Antifoaming agent | 1 |
| Water | make up to 100 |

The application and washing conditions for this composition were the same as those in Example 6. The results obtained are summarized in Table VII below.

TABLE VII

| Days | | | | | |
|---|---|---|---|---|---|
| after the | | | | | |
| pouring | | | | | |
| of the | Results obtained | | | | |
| concrete | Ex. 6 | Ex. 7 | Ex. 8 | Ex. 9 | Ex. 10 |
| 2 | ++ | ++ | ++ | ++ | ++ |
| 5 | ++ | ++ | ++ | ++ | ++ |
| 8 | ++ | ++ | ++ | ++ | ++ |

The results show that the deactivating compositions used in Examples 6 to 10 make it possible to obtain a sanded surface of unvarying depth after cleaning of the surface layer. The duration of action of the deactivating compositions is between two days and at least eight days.

### EXAMPLE 11

In this example, a “ready-mixed” mortar Chapdur Décor Désactivé® (SIKA) was prepared according to the manufacturer's instructions. The concrete slabs were poured with this mortar according to the same procedure as in Example 1. The formula of the deactivating composition used is as follows (proportions expressed as percentages by weight):

| | |
|---|---|
| Glucose | 1 |
| Aromatic ethoxylate | 0.5 |
| Polyether polyol | 1.5 |
| HMASE | 35 |
| Oil in emulsion | 7 |
| Bentone | 1 |
| Biocide | 0.5 |
| Antifoaming agent | 1 |
| Water | make up to 100 |

The amount of deactivating composition applied was 0.19 litre per square metre. The temperature was 15° C. during the test with a high degree of humidity.

A washing-out stage was carried out at various times by applying a jet of pressurized water to the concrete slab coated with deactivating agent. The results obtained are summarized in Table VIII below.

TABLE VII

| Days after the pouring | |
|---|---|
| of the concrete | Results obtained |
| 1 | −/+ |
| 2 | ++ |
| 3 | ++ |
| 4 | − |

### EXAMPLE 12

In this example, a “ready-mixed” mortar Chapdur Décor Désactivé® (SIKA) was prepared according to the manufacturer's instructions. The concrete slabs were poured with this mortar according to the same procedure as in Example 1. The formula of the deactivating composition used is as follows (proportions expressed as percentages by weight):

| | |
|---|---|
| Glucose | 1 |
| Aromatic ethoxylate | 0.5 |
| HMASE | 35 |
| Oil in emulsion | 7 |
| Bentone | 1 |
| Biocide | 0.5 |
| Antifoaming agent | 1 |
| Water | make up to 100 |

The amount of deactivating composition applied was 0.19 litre per square metre. The temperature was 15° C. during the test with a high degree of humidity.

A washing-out stage was carried out at various times by applying a jet of pressurized water to the concrete slab coated with deactivating agent. The results obtained are summarized in Table IX below.

TABLE IX

| Days after the pouring | |
|---|---|
| of the concrete | Results obtained |
| 1 | −/+ |
| 2 | + |
| 3 | − |
| 4 | − |

The comparison of example 11 and examples 12, which differ by the additional presence of a polyol in the deactivation composition, show the beneficial effect of said polyol.

1) Surface-deactivating composition for concrete or mortar comprising at least one surface retarder, characterized in that it additionally comprises at least one nonionic surfactant.

2) Composition according to claim 1, characterized in that the nonionic surfactant is chosen from polyethylene glycol esters, fatty acid esters, ethoxylates (polyoxyethylenated or polyoxypropylenated ethers of fatty alcohols or of fatty acids), sucrose, sorbitol and pentaerythritol esters, and, finally, oxyethylenated or oxypropylenated derivatives of fatty acid esters, aminoalcohols, amides and amines.

3) Composition according to claim 1, characterized in that the surface retarder is chosen from a phosphate, an aminophenol, a carbohydrate, or a carboxylic or hydroxycarboxylic acid or acid salt, such as gluconic or glucoheptonic acid or sodium gluconate or glucoheptonate.

4) Composition according to claim 1, characterized in that amount (by weight) of nonionic surfactant in the composition is between 0.2 and 5%, preferably between 0.3 and 3%.

5) Composition according to claim 1, characterized in that the amount (by weight) of surface retarder in the composition is between 0.05 and 25%, preferably between 0.1 and 15%.

6) Composition according to claim 1, characterized in that it additionally comprises at least one polyol.

7) Composition according to claim 1, characterized in that the polyol is chosen from a polyether polyol, a modified polyether polyol comprising a polyurea or a polyurethane in dispersion, a polyvinyl-modified polyether, a polyester polyol, a polycarbonate polyol, a polycaprolactone polyol or a glycol.

8) Composition according to claim 7, characterized in that the polyol is chosen from a diol and a triol.

9) Composition according to claim 1, characterized in that the amount (by weight) of polyols in the composition is between 0.1 and 15%, preferably between 0.1 and 10%.

10) Composition according to claim 1, characterized in that it additionally comprises an aqueous emulsion, soluble in alkalis, of a hydrophobically modified acrylic resin (HMASE) as rheology modifier.

11) Composition according to claim 10, characterized in that the concentration of rheology modifier of the emulsion in the composition is between 20 and 50%, preferably between 30 and 40%.

12) Composition according to claim 1, characterized in that it additionally comprises a cutting oil.

13) Composition according to claim 12, characterized in that the concentration of cutting oil in the composition is between 5 and 10%.

14) Process for deactivating the surface of a concrete or of a mortar during the setting thereof, comprising a stage of application of a deactivating composition according to claim 1 in proportions of the order of 0.20±0.05 litre per square metre of the said surface and a stage of washing this surface with water after a predetermined period.

15) Use of a nonionic surfactant for the preparation of a surface-deactivating composition for concrete or mortar, characterized in that the said composition is as defined in claim 1.
